(19) United States
(12) Patent Application Publication
(10) Pub. No.: US 2023/0002602 A1
(43) Pub. Date: Jan. 5, 2023

(54) POLYPROPYLENE-BASED RESIN COMPOSITION AND MOLDED PRODUCT THEREOF

(71) Applicant: PRIME POLYMER CO., LTD., Tokyo (JP)

(72) Inventors: Satoshi KUSHI, Funabashi-shi, Chiba (JP); Yusuke FUKUDA, Ichihara-shi, Chiba (JP); Shuichi TAKAHASHI, Ichihara-shi, Chiba (JP)

(73) Assignee: PRIME POLYMER CO., LTD., Tokyo (JP)

(21) Appl. No.: 17/784,100

(22) PCT Filed: Feb. 12, 2021
(86) PCT No.: PCT/JP2021/005280

§ 371 Date: Jun. 9, 2022

(30) Foreign Application Priority Data
Mar. 23, 2020 (JP) 2020-050549

(51) Int. Cl. C08L 23/12; C08L 23/16; C08L 23/08

(52) U.S. Cl. CPC C08L 23/12; C08L 23/16; C08L 23/0815; C08L 2205/02

(57) ABSTRACT

A molded product of a polypropylene-based resin composition, without containing an inorganic filler, and obtained by a polypropylene-based resin composition that does not contain an inorganic filler and includes: 60 to 90 parts by mass of a polypropylene-based resin (A) including 30 to 80 parts of a propylene-based polymer (a-1) having an MFR of 120 to 250 g/10 min and having 98 to 100 mol % of a propylene constituent unit, and 0 to 30 parts of a propylene/ethylene copolymer (a-2) having an intrinsic viscosity [η] of 4 to 7 dl/g and having 30 to 60 mol % of an ethylene constituent unit; 10 to 40 parts of an ethylene/α-olefin copolymer (B) having an MFR of 0.1 to 7 g/10 min and having an ethylene content of 65 to 90 mol %; 0.2 to 1 part of a fatty acid amide (C); and 0.1 to 1 part of a surfactant (D).

### TECHNICAL FIELD

The present invention relates to a polypropylene-based resin composition and a molded product thereof, and more particularly to a polypropylene-based resin composition and a molded product thereof suitable for producing an automobile interior or exterior member such as a pillar trim, a door trim, and a door panel.

### BACKGROUND ART

An attempt has been made to use various resins that are lightweight and have excellent moldability as raw materials for an automobile interior or exterior member such as a pillar trim, a door trim, and a door panel. For example, a member in which the surface of an acrylonitrile-styrene-based resin (AS-based resin) or a polypropylene-based resin (PP-based resin) is covered with a skin of a soft resin such as polyvinyl chloride and decorated in a leather-like manner, and a member in which a grained AS-based resin or PP-based resin surface is coated and decorated in a leather-like manner are used.

In recent years, there has been an increasing demand for simplification of an automobile production step and recycling of a used material. From such a point, there is an increasing demand for using a resin molded product having undergone surface processing such as graining even in an automobile interior or exterior member without coating the resin molded product. However, the uncoated PP-based resin molded product is likely to be scratched when assembled and used.

Accordingly, the following methods and compositions for producing a molded product having a suitable property as an automobile interior or exterior member and having excellent scratch resistance have been proposed.
A method for improving the strength using a filler (see Patent Literature 1).
A method for improving the hardness by using a resin component having excellent crystallinity (see Patent Literature 2).
A polypropylene-based composition including talc and a scratch improving agent and having excellent Izod impact strength and scratch resistance (see Patent Literature 3).
A propylene-based resin composition including a specific propylene/ethylene block copolymer, talc, and a fatty acid amide, and having excellent resistance to whitening that occurs when a protruding portion is formed (protrusion whitening resistance) and scratch resistance (see Patent Literature 4).
A polypropylene-based resin composition including three specific polypropylenes and a specific ethylene/α-olefin copolymer rubber and having excellent physical property balance and scratch resistance (see Patent Literature 5).

Further, in the application of an automobile interior or exterior member, not only a scratch such as scratching but also deterioration of the surface condition of an automobile interior or exterior member due to rubbing with a soft substance such as rubber becomes problematic. The reason is that, for example, the surface of the automobile interior or exterior member is likely to be kicked by the sole of a shoe. Accordingly, a polypropylene-based resin composition including two specific polypropylene-based resins, a specific ethylene/α-olefin copolymer, a fatty acid amide (lubricant), and a surfactant, and having excellent foot kick scratch resistance (see Patent Reference 6) has been proposed.

In addition, a polypropylene-based resin composition that is excellent in foot kick scratch resistance and other surface properties and can reduce the content of an inorganic filler, by setting the ratio between the viscosity [(A)η] of a polypropylene-based resin (A) and the viscosity [(B)η] of an ethylene/α-olefin copolymer (B) measured under specific conditions, [(B)η/(A)η], to be within a specific low range (see Patent Literature 7) has also been proposed.

### CITATION LIST

### Patent Literature

Patent Literature 1: JP 2009-079117 A
Patent Literature 2: JP 2012-132024 A
Patent Literature 3: JP 2002-060560 A
Patent Literature 4: JP 2003-055529 A
Patent Literature 5: JP 2004-051769 A
Patent Literature 6: WO 2014/046086 A
Patent Literature 7: WO 2019/117185 A

### SUMMARY OF INVENTION

### Technical Problem

The present inventors have considered that the conventional polypropylene-based resin compositions described above have room for further improvement in foot kick scratch resistance and impact resistance when these compositions do not contain an inorganic filler. That is, an object of the present invention is to provide a polypropylene-based resin composition and a molded product thereof that are, without containing an inorganic filler, excellent in foot kick scratch resistance and excellent in impact resistance

### Solution to Problem

As a result of diligent studies to solve the above problem, the present inventors have found that a polypropylene-based resin composition including a specific amount of a specific component is very effective, and completed the present invention. That is, the subject matter of the present invention is as follows.

[1] A polypropylene-based resin composition that does not contain an inorganic filler,

the composition including:
(A) a polypropylene-based resin including
(a-1) 30 parts by mass or more and 80 parts by mass or less of a propylene-based polymer having a melt flow rate (MFR, 230° C., load of 21.16 N) measured by a method according to JIS K 7210 of 120 g/10 min or more and 250 g/10 min or less, a content of a constituent unit derived from propylene of 98 mol % or more and 100 mol % or less, and a content of a constituent unit derived from at least one olefin selected from the group consisting of ethylene and an α-olefin having 4 to 8 carbon atoms of 0 mol % or more and 2 mol % or less, and
(a-2) 0 parts by mass or more and 30 parts by mass or less of a propylene/ethylene copolymer in which an intrinsic viscosity [η] measured in 135° C. decalin is 4 dl/g or more and 7 dl/g or less and a content of a constituent unit derived from ethylene is 30 mol % or more and 60 mol % or less, provided that a total amount of (a-1) and (a-2) is 60 parts by mass or more and 90 parts by mass or less; and
(B) 10 parts by mass or more and 40 parts by mass or less of an ethylene/α-olefin copolymer including ethylene and at least one α-olefin selected from an α-olefin having 3 to 8 carbon atoms in which a melt flow rate (MFR, 230° C., load of 21.16 N) measured by a method according to JIS K 7210 is 0.1 g/10 min or more and 7 g/10 min or less, and an ethylene content is 65 mol % or more and 90 mol % or less, provided that a total amount of (A) and (B) is 100 parts by mass,
the composition further including:
per 100 parts by mass in total of (A) and (B),
(C) 0.2 parts by mass or more and 1 part by mass or less of a fatty acid amide; and
(D) 0.1 parts by mass or more and 1 part by mass or less of a surfactant.

[2] The polypropylene-based resin composition according to the [1], wherein the melt flow rate (MFR, 230° C., load of 21.16 N) measured by a method according to JIS K 7210 of the propylene-based polymer is 120 g/10 min or more and 200 g/10 min or less.

[3] The polypropylene-based resin composition according to the [1] or [2], wherein the fatty acid amide is one or more fatty acid amides selected from the group consisting of a fatty acid amide having 8 to 25 carbon atoms and a dimer thereof.

[4] The polypropylene-based resin composition according to any one of the [1] to [3], wherein the surfactant is a compound having one or two ester groups having 8 to 25 carbon atoms.

[5] A molded product including the polypropylene-based resin composition according to any one of the [1] to [4].

[6] The molded product according to the [5], wherein the molded product is an injection molded product.

[7] The molded product according to the [5] or [6], wherein the molded product is an automobile interior or exterior member.

[8] The molded product according to the [7], wherein the molded product is an automobile door member or a pillar member.

### Advantageous Effects of Invention

According to the present invention, it is possible to provide a polypropylene-based resin composition and a molded product thereof that are, without containing an inorganic filler, excellent in foot kick scratch resistance and excellent in impact resistance. Further, the polypropylene-based resin composition and the molded product according to the present invention do not contain an inorganic filler, and thus may also be advantageous in terms of weight reduction. Therefore, the molded product of the present invention can be suitably used for an application that requires those properties, particularly the application of an automobile interior or exterior member such as an automobile door member and a pillar member.

### BRIEF DESCRIPTION OF DRAWING

FIG. 1 shows a schematic diagram for describing a scuff test in Examples.

### DESCRIPTION OF EMBODIMENTS

<Polypropylene-Based Resin (A)>

The polypropylene-based resin as the component (A) [also referred to as a polypropylene-based resin (A)] of the polypropylene-based resin composition according to the present invention includes a propylene-based polymer (a-1) as an essential component, and as necessary, includes a propylene/ethylene copolymer (a-2).

The propylene-based polymer as the component (a-1) [also referred to as a propylene-based polymer (a-1)] included in the polypropylene-based resin (A) is a homopolymer of propylene or a copolymer of propylene and a small amount of an olefin other than propylene (substantially a homopolymer). Here, examples of the olefin other than propylene include at least one olefin selected from the group consisting of ethylene and an α-olefin having 4 to 8 carbon atoms, and ethylene is preferred.

In the propylene-based polymer (a-1), the content of a constituent unit derived from propylene is 98 mol % or more and 100 mol % or less, and the content of a constituent unit derived from at least one olefin selected from the group consisting of ethylene and an α-olefin having 4 to 8 carbon atoms is 0 mol % or more and 2 mol % or less. The propylene-based polymer (a-1) is preferably a propylene homopolymer.

The melt flow rate (MFR, 230° C., load of 21.16 N) measured by a method according to JIS K 7210 of the propylene-based polymer (a-1) is 120 g/10 min or more and 250 g/10 min or less. When this MFR is 120 g/10 min or more, excellent foot kick scratch resistance tends to be developed. In addition, when this MFR is 250 g/10 min or less, excellent impact resistance tends to be developed, and for example, performance such as impact resistance required for an automobile interior or exterior member such as an automobile door member and a pillar member tends to be fully satisfied. This MFR is preferably 120 g/10 min or more and 220 g/10 min or less, more preferably 120 g/10 min or more and 200 g/10 min or less, further preferably 120 g/10 min or more and less than 200 g/10 min, and further preferably 120 g/10 min or more and 190 g/10 min or less.

The method for producing the propylene-based polymer (a-1) is not particularly limited. For example, the propylene-based polymer (a-1) can be obtained by homopolymerizing propylene or as necessary, copolymerizing propylene and a small amount of an olefin other than propylene, in the presence of a known catalyst for olefin polymerization.

Specific examples of the catalyst for olefin polymerization include a titanium-based catalyst and a metallocene-based catalyst.

The propylene-based polymer (a-1) can be prepared from one propylene-based polymer or by combining two or more propylene-based polymers that are different in at least one of MFR and the content of a constituent unit derived from an olefin.

For example, by combining at least one propylene-based polymer having an MFR lower than the target MFR and at least one propylene-based polymer having an MFR higher than the target MFR, a propylene-based polymer (a-1) having the target MFR may be prepared.

The propylene/ethylene copolymer as the component (a-2) [also referred to as a propylene/ethylene copolymer (a-2)] included as necessary in the polypropylene-based resin (A) may be a block copolymer or a random copolymer. In particular, a block copolymer is preferred.

In the propylene/ethylene copolymer (a-2), the content of a constituent unit derived from ethylene is 30 mol % or more and 60 mol % or less, preferably 30 mol % or more and 55 mol % or less, and more preferably 30 mol % or more and 50 mol % or less.

The intrinsic viscosity [η] of the propylene/ethylene copolymer (a-2) measured in 135° C. decalin is 4 dl/g or more and 7 dl/g or less. When this intrinsic viscosity [η] is 4 dl/g or more, excellent foot kick scratch resistance tends to be developed. In addition, when this intrinsic viscosity [η] is 7 dl/g or less, excellent impact resistance tends to be developed, and for example, performance such as impact resistance required for an automobile interior or exterior member such as an automobile door member and a pillar member tends to be fully satisfied. This intrinsic viscosity [η] is preferably 4.1 dl/g or more and 6.8 dl/g or less, and more preferably 4.2 dl/g or more and 6.5 dl/g or less.

The method for producing the propylene/ethylene copolymer (a-2) is not particularly limited. For example, the propylene/ethylene copolymer (a-2) can be obtained by copolymerizing propylene and ethylene in the presence of a known olefin polymerization catalyst. Specific examples of the catalyst for olefin polymerization include a titanium-based catalyst and a metallocene-based catalyst.

The propylene/ethylene copolymer (a-2) can be prepared from one propylene/ethylene copolymer or by combining two or more propylene/ethylene copolymers that are different in at least one of intrinsic viscosity and the content of a constituent unit derived from ethylene.

For example, by combining at least one propylene/ethylene copolymer having an intrinsic viscosity lower than the target intrinsic viscosity and at least one propylene/ethylene copolymer having an intrinsic viscosity higher than the target intrinsic viscosity, a propylene/ethylene copolymer (a-2) having the target intrinsic viscosity may be prepared.

In the polypropylene-based resin (A), the proportion of the propylene-based polymer (a-1) is 30 parts by mass or more and 80 parts by mass or less, preferably 45 parts by mass or more and 80 parts by mass or less, and more preferably 55 parts by mass or more and 80 parts by mass or less. The proportion of the propylene/ethylene copolymer (a-2) is 0 parts by mass or more and 30 parts by mass or less, preferably 0 parts by mass or more and 20 parts by mass or less, and more preferably 0 parts by mass or more and 15 parts by mass or less.

When the polypropylene-based resin (A) includes the propylene/ethylene copolymer (a-2), the lower limit of the proportion range of the propylene/ethylene copolymer (a-2) is preferably 0.01 parts by mass, more preferably 0.05 parts by mass, and further preferably 0.1 parts by mass.

These proportions are per 100 parts by mass in total of the polypropylene-based resin (A) and the ethylene/α-olefin copolymer (B) described later, and show proportions in 100 parts by mass in total of the polypropylene-based resin (A) and the ethylene/α-olefin copolymer (B) described later.

The sum of the proportion of the propylene-based polymer (a-1) and the proportion of the propylene/ethylene copolymer (a-2) corresponds to the proportion of the polypropylene-based resin (A) in 100 parts by mass in total of the polypropylene-based resin (A) and the ethylene/α-olefin copolymer (B) described later. Therefore, the proportion of the propylene-based polymer (a-1) and the proportion of the propylene/ethylene copolymer (a-2) are selected from the above respective ranges such that the sum of these is 60 parts by mass or more and 90 parts by mass or less to prepare the polypropylene-based resin (A).

When the polypropylene-based resin (A) does not include a propylene/ethylene copolymer (a-2), the propylene-based polymer (a-1) may be used as the polypropylene-based resin (A).

When the polypropylene-based resin (A) includes a propylene/ethylene copolymer (a-2), for example, the following resin materials can be used as the polypropylene-based resin (A).

(A1) A mixture of a propylene-based polymer (a-1) and a propylene/ethylene copolymer (a-2).
(A2) A block copolymer (a-3) having a segment of a propylene-based polymer (a-1) and a segment of a propylene/ethylene copolymer (a-2).
(A3) A mixture of at least one of a propylene-based polymer (a-1) and a propylene/ethylene copolymer (a-2) and the block copolymer (a-3).

Among these resin materials, the resin material (A3) is preferred, and a mixture of a propylene-based polymer (a-1) and the block copolymer (a-3) is further preferred.

<Ethylene/α-Olefin Copolymer (B)>

The ethylene/α-olefin copolymer as the component (B) [also referred to as an ethylene/α-olefin copolymer (B)] used in the present invention is a copolymer including ethylene as the main component. As the α-olefin, at least one α-olefin selected from the group consisting of an α-olefin having 3 to 8 carbon atoms is preferred, and at least one α-olefin selected from the group consisting of propylene, 1-butene, 1-hexene, and 1-octene is more preferred. Of these, 1-butene and 1-octene are particularly preferred.

The melt flow rate (MFR, 230° C., load of 21.16 N) measured by a method according to JIS K 7210 of the ethylene/α-olefin copolymer (B) is 0.1 g/10 min or more and 7 g/10 min or less. When this MFR is 0.1 g/10 min or more, excellent impact resistance tends to be developed, and for example, performance such as impact resistance required for an automobile interior or exterior member such as an automobile door member and a pillar member tends to be fully satisfied. In addition, when this MFR is 7 g/10 min or less, excellent foot kick scratch resistance tends to be developed. This MFR is preferably 0.5 g/10 min or more and 7 g/10 min or less, and more preferably 0.5 g/10 min or more and 5 g/10 min or less.

The ethylene content of the ethylene/α-olefin copolymer (B) is 65 mol % or more and 90 mol % or less, and preferably 75 mol % or more and 85 mol % or less.

<Fatty Acid Amide (C)>

The fatty acid amide as the component (C) [also referred to as a fatty acid amide (C)] used in the present invention may be a saturated fatty acid amide or an unsaturated fatty acid amide. As the fatty acid amide (C), one or more fatty acid amides selected from the group consisting of a fatty acid amide having 8 to 25 carbon atoms and a dimer thereof are preferred, a fatty acid amide having 8 to 25 carbon atoms is more preferred, and a fatty acid amide having 15 to 25 carbon atoms is particularly preferred.

Specific examples of the fatty acid amide (C) include oleic amide, stearic amide, erucic amide, behenic amide, palmitic amide, myristic amide, lauric amide, capric amide, caproic amide, n-oleyl palmitamide, n-oleyl erucamide, and dimers thereof. Of these, oleic amide, stearic amide, erucic amide, behenic amide, and dimers thereof are preferred. As the fatty acid amide (C), one may be used alone or two or more may be used in combination.

<Surfactant (D)>

The type of the surfactant as the component (D) [also referred to as a surfactant (D)] used in the present invention is not particularly limited, and a known surfactant can be used. In particular, a surfactant that acts as an antistatic agent in the polypropylene-based resin composition is preferred.

Typical example of the surfactant (D) includes an ester-type surfactant. As the ester-type surfactant, a compound having one or more ester groups having 8 to 25 carbon atoms is preferred, and a compound having one or more ester groups having 15 to 25 carbon atoms is more preferred. The number of ester groups in these compounds is preferably one or two. Specific examples of the ester-type surfactant include a glycerin fatty acid ester, a diglycerin fatty acid ester, a sorbitan fatty acid ester, a sucrose fatty acid ester, an alkyl glucoside, and a polycarboxylic acid ester. Of these, a glycerin fatty acid ester and a diglycerin fatty acid ester are preferred.

Specific examples of the glycerin fatty acid ester (that is, a fatty acid monoglyceride) include monoglyceride stearate, monoglyceride oleate, monoglyceride linoleate, monoglyceride laurate, monoglyceride palmitate, monoglyceride myristate, monoglyceride behenate, and monoglyceride margarate. Of these, monoglyceride stearate and monoglyceride oleate are preferred.

Specific examples of the diglycerin fatty acid ester (that is, a fatty acid diglyceride) include diglyceride stearate, diglyceride oleate, diglyceride linoleate, diglyceride laurate, diglyceride palmitate, diglyceride myristate, diglyceride behenate, and diglyceride margarate. Of these, diglyceride stearate and diglyceride oleate are preferred.

<Other Additives>

Into the polypropylene-based resin composition of the present invention, as necessary, at least one of other additives such as a heat stabilizer, a weathering stabilizer, a light stabilizer, an anti-aging agent, an antioxidant, a fatty acid metal salt, a softener, a dispersant, a colorant, a pigment, an ultraviolet absorber, and a nucleating agent may be blended as long as the object of the present invention is not impaired.

The mixing order of each component to be blended is arbitrary. Each component may be mixed at the same time, or a multi-stage mixing method in which some components are mixed and then the other components are mixed may be used.

<Polypropylene-Based Resin Composition>

The polypropylene-based resin composition of the present invention does not contain an inorganic filler, that is, is an inorganic filler-free polypropylene-based resin composition, and includes the components (A) to (D) described above.

Specific examples of the inorganic filler include inorganic fillers as described in Patent Literatures 1, 5, 6, and 7 cited above, but in the present invention, the polypropylene-based resin composition is prepared without using such inorganic fillers.

Hereinafter, the amount of each component included in the polypropylene-based resin composition of the present invention will be described. The amount of each of the following components is per 100 parts by mass in total of the components (A) and (B).

The amount of the polypropylene-based resin (A) is 60 parts by mass or more and 90 parts by mass or less, which is the total amount of the polypropylene-based resin (a-1) and the propylene/ethylene copolymer (a-2), preferably 65 parts by mass or more and 90 parts by mass or less, and more preferably 70 parts by mass or more and 90 parts by mass or less.

The amount of the ethylene/α-olefin copolymer (B) is 10 parts by mass or more and 40 parts by mass or less, preferably 10 parts by mass or more and 35 parts by mass or less, and more preferably 10 parts by mass or more and 30 parts by mass or less.

The amount of the fatty acid amide (C) is 0.2 parts by mass or more and 1 part by mass or less, preferably 0.2 parts by mass or more and 0.8 parts by mass or less, and more preferably 0.2 parts by mass or more and 0.6 parts by mass or less.

The amount of the surfactant (D) is 0.1 parts by mass or more and 1 part by mass or less, preferably 0.1 parts by mass or more and 0.5 parts by mass or less, and more preferably 0.1 parts by mass or more and 0.4 parts by mass or less.

The order of blending each component described above is arbitrary. For example, a polypropylene-based resin composition can be obtained by mixing or melt-kneading each component using a mixing apparatus such as a Banbury mixer, a single-screw extruder, a twin-screw extruder, or a high-speed twin-screw extruder.

<Molded Product>

The polypropylene-based resin composition of the present invention can be used in various molding methods. Specific examples of the molded product of the present invention include an injection molded product, a foam molded product, an injection foam molded product, an extruded product, a blow molded product, a vacuum/pressure formed body, a calendered body, a stretched film, and an inflation film. In particular, an injection molded product is preferred. The molding condition for producing a molded product is not particularly limited, and a known condition can be adopted.

The application of the molded product of the present invention is not particularly limited. Specific examples of a suitable application include an automobile interior or exterior member such as a door panel, a pillar trim, a door trim, a door lower garnish, and an instrument panel, an engine compartment peripheral part, other automobile parts, a home appliance part, a food container, a beverage container, and a medical container. Of these, the application of an automobile interior or exterior member is preferred, and the application of an automobile door member and the application of a pillar member are particularly preferred.

### EXAMPLES

Hereinafter, the present invention will be described further specifically based on Examples and Comparative Examples. However, the present invention is not limited to these Examples.

In the Examples and the Comparative Examples, various physical properties were measured or evaluated by the following methods.

[MFR (Melt Flow Rate)]

MFR was measured under conditions of a load of 21.16 N and a temperature of 230° C. according to JIS K 7210.

When a mixture of a plurality of polypropylene-based resins is used as the polypropylene-based resin (A), for the measurement of the MFR of the entire propylene-based polymer component included in the mixture (“(a-1) MFR” in Tables 2 to 4), the mixture was heated and dissolved in a decane solution at 145° C., the solution thus obtained was returned to room temperature, and the solid recovered by filtration was used for measurement.

[Content of Propylene Constituent Unit in Propylene-Based Polymer and Content of Ethylene Constituent Unit in Propylene/Ethylene Copolymer]

These were measured by Fourier transform infrared spectroscopy (FT-IR).

For the measurement of “Content of constituent unit derived from propylene” and “Content of constituent unit derived from ethylene” in the propylene/ethylene block copolymer (bPP) in Table 1, the propylene/ethylene block copolymer was heated and dissolved in a decane solution at 145° C., the resulting solution was returned to room temperature, and the solid recovered by filtration was used for the measurement of the content of a constituent unit derived from propylene, and acetone was added to the solution after filtration, filtered, and recovered, and the solid obtained by volatilizing acetone was used for the measurement of the content of a constituent unit derived from ethylene.

[Intrinsic Viscosity (η)]

About 20 mg of a sample was dissolved in 15 ml of decalin, and the specific viscosity ηₛₚ was measured in an oil bath at 135° C. 5 ml of a decalin solvent was added to this decalin solution for dilution, and then the specific viscosity ηₛₚ was measured in the same manner. This dilution operation was repeated twice more, and the value of ηₛₚ/C when the concentration (C) was extrapolated to 0 was determined as the intrinsic viscosity [η].

[η]=lim(ηₛₚ/C) (C→0)

[Scuff Test (Scratch Resistance Test Using Rubber Rubbing)]

A molded product having a grain on the surface produced by injection molding a resin composition into a mold and allowed to stand at a constant temperature of 23° C. for 2 days or more after molding to be conditioned was used as a specimen (length of 240 mm, width of 80 mm, thickness of 3 mm).

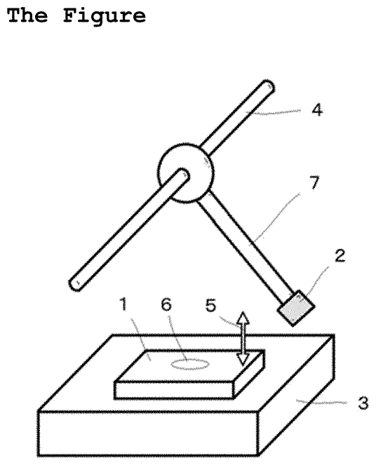

For evaluation, the scuff test apparatus shown in FIG. 1 was used. This scuff test apparatus is equipped with a base 3 for fixing the specimen 1 using a fixture (not shown in FIG. 1), a metal pendulum 7 with a rubbing object (rubber testing piece) 2 attached to the tip, and a pantograph 4. As the rubbing object (rubber testing piece) 2, a rubber piece (manufactured by Honda Motor Co., Ltd., product number 18215-SA0-000) having a Shore A surface hardness of 75 was used. This apparatus reproduces the state of foot kicking by the sole of a shoe by operating the pendulum 7 from a height 5 of 20 cm from a scratch test surface 6 of the specimen 1, and passing the rubbing object (rubber testing piece) 2 attached to the tip of the pendulum 7 over the test surface 6 of the specimen 1 while rubbing the same thereagainst.

Specifically, the test was carried out by two operators according to the following operating procedure.

1. The specimen 1 was fixed on the base 3 of the apparatus.
2. The digital depth gage was set on the upper portion of the pendulum 7, the tip of the gage was contacted with the upper portion of the pendulum 7, and it was confirmed that the gage indicated 0 mm on the scale.
3. The lever of the pantograph 4 was rotated to raise the base 3 such that the gage indicated 0.3 mm on the scale.
4. The tip of the pendulum 7 to which the rubber testing piece 2 was attached was lifted to a height 5 of 20 cm from the scratch test surface 6.
5. The pendulum 7 was released, and the rubber testing piece 2 was rubbed against the test surface 6 of the specimen 1.

Then, the state of the test surface 6 was visually confirmed and evaluated according to the following criteria. In the evaluation results, grade 5 indicates the best and grade 1 indicates the worst.

“1”: Whitening of the surface of the rubbed portion was remarkably noticeable.
“2”: Whitening of the surface of the rubbed portion was noticeable.
“3”: The surface of the rubbed portion was slightly whitened.
“4”: The rubbed portion had a trace of rubber rubbing but was free from whitening.
“5”: There was no trace of rubber rubbing or whitening.

[Izod Impact Test]

The Izod impact strength (J/m) was measured under a condition of a test temperature of 23° C. according to ASTM D256.

[Bending Test]

The flexural modulus (MPa) was measured under conditions of a test temperature of 23° C. and a test speed of 30 ram/min according to ASTM D790.

Each component used in the Examples and the Comparative Examples is as follows.

<Polypropylene-Based Resin (A)>

“A1”: Propylene/ethylene block copolymer (manufactured by Prime Polymer Co., Ltd., MFR (230° C., 2.16 kg)=70 g/10 min)
“A2”: Propylene homopolymer (manufactured by Prime Polymer Co., Ltd., trade name J137M, MFR (230° C., 2.16 kg)=30 g/10 min)
“A3”: Propylene homopolymer (manufactured by Prime Polymer Co., Ltd., trade name J13B, MFR (230° C., 2.16 kg)=200 g/10 min)
“A4”: Propylene/ethylene block copolymer (manufactured by Prime Polymer Co., Ltd., MFR (230° C., 2.16 kg)=60 g/10 min)
“A5”: Propylene/ethylene block copolymer (manufactured by Prime Polymer Co., Ltd., MFR (230° C., 2.16 kg)=80 g/10 min)
“A6”: Propylene/ethylene block copolymer (manufactured by Prime Polymer Co., Ltd., MFR (230° C., 2.16 kg)=95 g/10 min)
“A7”: Propylene/ethylene block copolymer (manufactured by Prime Polymer Co., Ltd., trade name J-452HP, MFR (230° C., 2.16 kg)=4 g/10 min)
“A8”: Propylene homopolymer (manufactured by Prime Polymer Co., Ltd., trade name F113A, MFR (230° C., 2.16 kg)=3 g/10 min)
“A9”: Propylene/ethylene block copolymer (manufactured by Prime Polymer Co., Ltd., trade name J715M, MFR (230° C., 2.16 kg)=9 g/10 min)

Details of the propylene-based polymer for (a-1) and the propylene/ethylene copolymer for the component (a-2) constituting the polypropylene-based resins (A1) to (A9) are shown in Table 1.

TABLE 1

| | | For propylene-based polymer (a-1) | | | | | | |
|---|---|---|---|---|---|---|---|---|
| | | | Content of | | For propylene/ethylene copolymer (a-2) | | | |
| | | | constituent | | | Content of | | |
| | | | unit derived | | Intrinsic | constituent unit | | |
| | | | from | | viscosity | derived from | | |
| | | MFR | propylene | Content | [η] | ethylene | | Content |
| | | g/10 min | mol % | wt % | dL/g | wt % | mol % | wt % |
| A1 | bPP | 150 | 100 | 89 | 3.3 | 30 | 39 | 11 |
| A2 | hPP | 30 | 100 | 100 | — | — | — | — |
| A3 | hPP | 200 | 100 | 100 | — | — | — | — |
| A4 | bPP | 180 | 100 | 88 | 6.3 | 30 | 39 | 12 |
| A5 | bPP | 275 | 100 | 89 | 7.5 | 30 | 39 | 11 |
| A6 | bPP | 270 | 100 | 89 | 4.5 | 30 | 39 | 11 |
| A7 | bPP | 5 | 100 | 85 | 2.4 | 30 | 39 | 15 |
| A8 | hPP | 3 | 100 | 100 | — | — | — | — |
| A9 | bPP | 15 | 100 | 88 | 3.3 | 30 | 39 | 12 |

<Ethylene/α-Olefin Copolymer (B)>

“B1”: Ethylene-1-octene copolymer (EOR) (manufactured by The Dow Chemical Company, ENGAGE (registered trademark) 8100, MFR (230° C., 2.16 kg)=2.0 g/10 min, ethylene content=80 mol %)
“B2”: Ethylene-1-octene copolymer (EOR) (manufactured by The Dow Chemical Company, ENGAGE (registered trademark) 8200, MFR (230° C., 2.16 kg)=9.0 g/10 min, ethylene content=80 mol %)

<Fatty Acid Amide (C)>

“C1”: Erucic amide (manufactured by Nippon Fine Chemical Co., Ltd., NEUTRON (registered trademark) S)

<Surfactant (D)>

“D-1”: Monoglyceride stearate (manufactured by Kao Corporation, Electrostripper (registered trademark) TS-5)

### Examples 1 to 10 and Comparative Examples 1 to 4

A polypropylene-based resin composition including each component (parts by mass) shown in Tables 2 to 4, and, as other additives, 0.1 parts by mass of a phenol-based antioxidant (manufactured by BASF, trade name Irganox (registered trademark) 1010), 0.05 parts by mass of a phosphorus-based antioxidant (manufactured by BASF, trade name Irgafos 168), 0.05 parts by mass of a hindered amine-based light stabilizer (manufactured by ADEKA Corporation, trade name LA-52), 0.05 parts by mass of an ultraviolet absorber (manufactured by BASF, trade name Tinuvin (registered trademark) 120), and 0.1 parts by mass of a nucleating agent (manufactured by ADEKA Corporation, trade name ADK STAB (registered trademark) NA-11) was prepared.

Then, each physical property of these polypropylene-based resin compositions was measured or evaluated by the above methods. Results are shown in Tables 2 to 4.

TABLE 2

| | | | | Example | Example | Example | Example | Example |
|---|---|---|---|---|---|---|---|---|
| | | | | 1 | 2 | 3 | 4 | 5 |
| Composition | Polypropylene- | A2 | parts by | 8 | 8 | 8 | | 8 |
| | based resin (A) | | mass | | | | | |
| | | A3 | parts by | 11 | 11 | 11 | 7 | 11 |
| | | | mass | | | | | |
| | | A4 | parts by | 60 | 60 | 60 | 73 | 60 |
| | | | mass | | | | | |
| | | Total | parts by | 79 | 79 | 79 | 80 | 79 |
| | | | mass | | | | | |
| | | (a-1) | g/10 min | 150 | 150 | 150 | 182 | 150 |
| | | MFR | | | | | | |
| | | (a-2) [η] | dL/g | 6.3 | 6.3 | 6.3 | 6.3 | 6.3 |
| | | (a-2) E | mol % | 39 | 39 | 39 | 39 | 39 |
| | | content | | | | | | |
| | Ethylene/-α-olefin | B1 | parts by | 21 | 21 | 21 | 20 | 21 |
| | copolymer (B) | | mass | | | | | |
| | | Total | parts by | 21 | 21 | 21 | 20 | 21 |
| | | | mass | | | | | |
| | | MFR | g/10 min | 2 | 2 | 2 | 2 | 2 |
| | Fatty acid | C1 | parts by | 0.50 | 0.25 | 0.25 | 0.30 | 0.30 |
| | amide (C) | | mass | | | | | |
| | Surfactant (D) | D1 | parts by | 0.30 | 0.30 | 0.15 | 0.30 | 0.30 |
| | | | mass | | | | | |

| | | | | | | | |
|---|---|---|---|---|---|---|---|
| Evaluation | Scuff test | Grade | 4 | 4 | 4 | 4 | 4 |
| | Izod impact strength (23° C.) | J/m | 622 | 645 | 641 | 655 | 618 |
| | MFR | g/10 min | 30 | 29 | 29 | 29 | 29 |
| | Flexural modulus | MPa | 1248 | 1223 | 1241 | 1193 | 1274 |

TABLE 3

| | | | | Example | Example | Example | Example | Example |
|---|---|---|---|---|---|---|---|---|
| | | | | 6 | 7 | 8 | 9 | 10 |
| Compostion | Polypropylene- | A2 | parts by | 3 | | | | 10 |
| | based resin (A) | | mass | | | | | |
| | | A3 | parts by | 7 | | | | |
| | | | mass | | | | | |
| | | A4 | parts by | 70 | | | | 40 |
| | | | mass | | | | | |
| | | A6 | parts by | | 72 | 68 | 70 | 30 |
| | | | mass | | | | | |
| | | A7 | parts by | | 10 | | | |
| | | | mass | | | | | |
| | | A8 | parts by | | | 12 | | |
| | | | mass | | | | | |
| | | A9 | parts by | | | | 11 | |
| | | | mass | | | | | |
| | | Total | parts by | 80 | 82 | 80 | 81 | 80 |
| | | | mass | | | | | |
| | | (a-1) MFR | g/10 min | 169 | 162 | 129 | 183 | 164 |
| | | (a-2) [η] | dL/g | 6.3 | 4.2 | 4.5 | 4.3 | 5.5 |
| | | (a-2) E | mol % | 39 | 39 | 39 | 39 | 39 |
| | | content | | | | | | |
| | Ethylene/α-olefin | B1 | parts by | 20 | 18 | 20 | 19 | 20 |
| | copolymer (B) | | mass | | | | | |
| | | Total | parts by | 20 | 18 | 20 | 19 | 20 |
| | | | mass | | | | | |
| | | MFR | g/10 min | 2 | 2 | 2 | 2 | 2 |
| | Fatty acid | C1 | parts by | 0.30 | 0.30 | 0.30 | 0.30 | 0.30 |
| | amide (C) | | mass | | | | | |
| | Surfactant (D) | D1 | parts by | 0.30 | 0.30 | 0.30 | 0.30 | 0.30 |
| | | | mass | | | | | |

| | | | | | | | |
|---|---|---|---|---|---|---|---|
| Evaluation | Scuff test | Grade | 4 | 4 | 4 | 4 | 4 |
| | Izod impact strength (23° C.) | J/m | 627 | 652 | 644 | 633 | 616 |
| | MFR | g/10 min | 29 | 31 | 28 | 35 | 31 |
| | Flexural modulus | MPa | 1242 | 1151 | 1209 | 1188 | 1237 |

TABLE 4

| | | | | Comparative | Comparative | Comparative | Comparative |
|---|---|---|---|---|---|---|---|
| | | | | Example 1 | Example 2 | Example 3 | Example 4 |
| Compostion | Polypropylene- | A1 | parts by | 74 | 74 | | |
| | based resin (A) | | mass | | | | |
| | | A2 | parts by | 5 | 5 | 8 | |
| | | | mass | | | | |
| | | A3 | parts by | | | 11 | 5 |
| | | | mass | | | | |
| | | A4 | parts by | | | 60 | |
| | | | mass | | | | |
| | | A5 | parts by | | | | 75 |
| | | | mass | | | | |
| | | Total | parts by | 79 | 79 | 79 | 80 |
| | | | mass | | | | |
| | | (a-1) | g/10 min | 112 | 112 | 150 | 268 |
| | | MFR | | | | | |
| | | (a-2) [η] | dL/g | 3.3 | 3.3 | 6.3 | 7.5 |
| | | (a-2) E | mol % | 39 | 39 | 39 | 39 |
| | | content | | | | | |
| | Ethylene/α-olefin | B1 | parts by | | 21 | | 20 |
| | copolymer (B) | | mass | | | | |
| | | B2 | parts by | 21 | | 21 | |
| | | | mass | | | | |
| | | Total | parts by | 21 | 21 | 21 | 20 |
| | | | mass | | | | |
| | | MFR | g/10 min | 9 | 2 | 9 | 2 |
| | Fatty acid amide | C1 | parts by | 0.50 | 0.50 | 0.50 | 0.50 |
| | (C) | | mass | | | | |
| | Surfactant (D) | D1 | parts by | 0.30 | 0.30 | 0.30 | 0.30 |
| | | | mass | | | | |

| | | | | | | |
|---|---|---|---|---|---|---|
| Evaluation | Scuff test | Grade | 2 | 3 | 3 | 4 |
| | Izod impact strength (23° C.) | J/m | 569 | 650 | 610 | 202 |
| | MFR | g/10 min | 38 | 27 | 40 | 35 |
| | Flexural modulus | MPa | 1174 | 1206 | 1223 | 1262 |

In Tables 2 to 4, “(a-1) MFR” indicates the MFR of the propylene-based polymer (a-1) included in the polypropylene-based resin (A), and “(a-2) [η]” and “(a-2) E content” indicate the intrinsic viscosity [η] and the content of a constituent unit derived from ethylene, respectively, of the propylene/ethylene copolymer (a-2) included in the polypropylene-based resin (A).

“MFR” in the “Evaluation” column of Tables 2 to 4 indicates the MFR of the polypropylene-based resin composition.

[Evaluation]

As is shown in Tables 2 to 4, the polypropylene-based resin compositions of Examples 1 to 10 were excellent in various performance. On the other hand, the polypropylene-based resin compositions of Comparative Examples 1 to 3 were inferior in performance such as foot kick scratch resistance, and the polypropylene-based resin composition of Comparative Example 4 was inferior particularly in impact resistance.

### INDUSTRIAL APPLICABILITY

The polypropylene-based resin composition of the present invention is useful as a material for producing various molded products such as an injection molded product. The molded product of the present invention is very useful particularly as an automobile interior or exterior member such as a door panel, a pillar trim, a door trim, a door lower garnish, and an instrument panel.

### REFERENCE SIGNS LIST

1 Specimen
2 Rubbing object (rubber testing piece)
3 Base
4 Pantograph
5 Pendulum height (20 cm)
6 Test surface
7 Pendulum

1. A polypropylene-based resin composition that does not contain an inorganic filler,
the composition comprising:
(A) a polypropylene-based resin comprising
(a-1) 30 parts by mass or more and 80 parts by mass or less of a propylene-based polymer having a melt flow rate (MFR, 230° C., load of 21.16 N) measured by a method according to JIS K 7210 of 120 g/10 min or more and 250 g/10 min or less, a content of a constituent unit derived from propylene of 98 mol % or more and 100 mol % or less, and a content of a constituent unit derived from at least one olefin selected from the group consisting of ethylene and an α-olefin having 4 to 8 carbon atoms of 0 mol % or more and 2 mol % or less, and
(a-2) 0 parts by mass or more and 30 parts by mass or less of a propylene/ethylene copolymer in which an intrinsic viscosity [η] measured in 135° C. decalin is 4 dl/g or more and 7 dl/g or less and a content of a constituent unit derived from ethylene is 30 mol % or more and 60 mol % or less,
provided that a total amount of (a-1) and (a-2) is 60 parts by mass or more and 90 parts by mass or less; and
(B) 10 parts by mass or more and 40 parts by mass or less of an ethylene/α-olefin copolymer comprising ethylene and at least one α-olefin selected from an α-olefin having 3 to 8 carbon atoms in which a melt flow rate (MFR, 230° C., load of 21.16 N) measured by a method according to JIS K 7210 is 0.1 g/10 min or more and 7 g/10 min or less, and an ethylene content is 65 mol % or more and 90 mol % or less,
provided that a total amount of (A) and (B) is 100 parts by mass,
the composition further comprising:
per 100 parts by mass in total of (A) and (B),
(C) 0.2 parts by mass or more and 1 part by mass or less of a fatty acid amide; and
(D) 0.1 parts by mass or more and 1 part by mass or less of a surfactant.

2. The polypropylene-based resin composition according to claim 1, wherein the melt flow rate (MFR, 230° C., load of 21.16 N) measured by a method according to JIS K 7210 of the propylene-based polymer is 120 g/10 min or more and 200 g/10 min or less.

3. The polypropylene-based resin composition according to claim 1, wherein the fatty acid amide is one or more fatty acid amides selected from the group consisting of a fatty acid amide having 8 to 25 carbon atoms and a dimer thereof.

4. The polypropylene-based resin composition according to claim 1, wherein the surfactant is a compound having one or two ester groups having 8 to 25 carbon atoms.

5. A molded product comprising the polypropylene-based resin composition according to claim 1.

6. The molded product according to claim 5, wherein the molded product is an injection molded product.

7. The molded product according to claim 5, wherein the molded product is an automobile interior or exterior member.

8. The molded product according to claim 7, wherein the molded product is an automobile door member or a pillar member.
